(19) United States
(12) Patent Application Publication
(10) Pub. No.: US 2018/0066548 A1
(43) Pub. Date: Mar. 8, 2018

(54) COMBINED CYCLE POWER PLANT HAVING AN INTEGRATED RECUPERATOR

(71) Applicant: General Electric Company, Schenectady, NY (US)

(72) Inventor: Sebastian Walter Freund, Munich (DE)

(21) Appl. No.: 15/257,917

(22) Filed: Sep. 7, 2016

(51) Int. Cl. F01K 23/10; F01K 7/16; F02C 3/04; H02K 7/18; F01D 15/10

(52) U.S. Cl. CPC F01K 23/10; F01K 7/16; F02C 3/04; F05D 2220/32; F01D 15/10; F05D 2220/62; H02K 7/1823

(57) ABSTRACT

A combined cycle power plant is provided. The combined cycle power plant includes a gas turbine and a heat recovery steam generator disposed in fluid communication with the gas turbine and including one or more steam heater units. Additionally, the combined cycle power plant includes a recuperator unit integrated with the heat recovery steam generator and configured to use gas turbine exhaust from the gas turbine to preheat compressor discharge air from the compressor and supply the preheated compressor discharge air to the combustor, where a first subset of the one or more steam heater units is disposed in parallel to the recuperator unit, and where a second subset of the one or more steam heater units is disposed in series with the first subset of the one or more steam heater units and the recuperator unit with respect to a direction of flow of gas turbine exhaust.

### BACKGROUND

Embodiments of the present specification relate to gas turbines, and more particularly to a heat recovery steam generator and an integrated recuperator for use in combined cycle power plants.

Combined cycle power plants are being increasingly used for power generation. Typically, the combined cycle power plant includes a gas turbine and a steam turbine. The gas turbine is used to generate electrical power by combusting a mixture of compressed air and natural gas. Further, exhaust heat from the gas turbine is captured via use of a Heat Recovery Steam Generator (HRSG). The HRSG creates steam from water using heat from the gas turbine exhaust and delivers the steam to the steam turbine. The steam turbine in turn is used to generate additional electrical power via use of the steam.

Moreover, a recuperator is used in the combined cycle power plant to enhance the efficiency of the combined cycle power plant. In particular, the recuperator uses the exhaust gases from the gas turbine to pre-heat the compressed air received from a compressor of the gas turbine. The pre-heated compressed air is mixed with natural gas for combustion in the gas turbine to generate the electrical power. Consequent to the use of the pre-heated compressed air, the requirement of natural gas for combustion in the gas turbine to generate electrical power is reduced.

However, using the recuperator in the combined cycle power plant results in a reduction in the efficiency of the steam cycle due to the non-availability of high-temperature exhaust gas for superheating and reheating the steam. Moreover, use of the recuperator in the combined cycle power plant leads to additional pressure losses in the exhaust gas flow, which in turn reduces the efficiency of the gas turbine. Furthermore, the recuperators used in the combined cycle power plants are bulky and expensive.

### BRIEF DESCRIPTION

Briefly, in accordance with one aspect of the present specification, a combined cycle power plant is presented. The combined cycle power plant includes a gas turbine, which in turn includes at least a compressor and a combustor. Furthermore, the combined cycle power plant includes a heat recovery steam generator disposed in fluid communication with the gas turbine, where the heat recovery steam generator includes steam heater units. Moreover, the combined cycle power plant includes a recuperator unit, where the recuperator unit is integrated with the heat recovery steam generator, and where the recuperator unit is configured to use gas turbine exhaust from the gas turbine to preheat compressor discharge air from the compressor and supply the preheated compressor discharge air to the combustor, where a first subset of the steam heater units is disposed in parallel to the recuperator unit, and where a second subset of the steam heater units is disposed in series with the first subset of the steam heater units and the recuperator unit with respect to a direction of flow of gas turbine exhaust.

In accordance with another aspect of the present specification, a heat recovery steam generator is presented. The heat recovery steam generator includes one or more steam heater units. Also, the heat recovery steam generator includes a heat recovery steam generator duct. In addition, the heat recovery steam generator includes a recuperator unit, where the recuperator unit is integrated with at least one of the one or more steam heater units, where the recuperator unit is configured to use gas turbine exhaust from the gas turbine to preheat compressor discharge air for the compressor and supply the preheated compressor discharge air to the combustor, where a first subset of the one or more steam heater units is disposed in parallel to the recuperator unit, and where a second subset of the one or more steam heater units is disposed in series with the first subset of the one or more steam heater units and the recuperator unit with respect to a direction of flow of the gas turbine exhaust.

In accordance with yet another aspect of the present specification, a combined cycle power plant is presented. The combined cycle power plant includes a gas turbine comprising at least a compressor and a combustor. Further, the combined cycle power plant includes a heat recovery steam generator disposed in fluid communication with the gas turbine, where the heat recovery steam generator includes one or more steam heater units, a heat recovery steam generator duct disposed in fluid communication with the gas turbine. In addition, the combined cycle power plant includes a recuperator unit configured to use gas turbine exhaust from the gas turbine to preheat compressor discharge air from the compressor and supply the preheated compressor discharge air to the combustor, where the recuperator unit is integrated with at least one of the one or more steam heater units of the heat recovery steam generator such that a plurality of recuperator tubes in the recuperator unit is disposed perpendicular to a direction of flow of the gas turbine exhaust in the heat recovery steam generator duct; and where the recuperator unit is arranged in a parallel configuration with the at least one of the one or more steam heater units such that a first smaller portion of the gas turbine exhaust discharged by the gas turbine is channeled over the at least one steam heater unit and a second larger portion of the gas turbine exhaust is channeled over recuperator unit. Also, a first subset of the one or more steam heater units is disposed in parallel to the recuperator unit, and where a second subset of the one or more steam heater units is disposed in series with the first subset of the one or more steam heater units and the recuperator unit with respect to a direction of flow of the gas turbine exhaust. The combined cycle power plant also includes a steam turbine operatively coupled to the heat recovery steam generator and configured to generate additional electrical power,

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of an exemplary combined cycle power plant having an integrated recuperator unit, according to aspects of the present specification;

FIG. 2 is a schematic representation of one embodiment of a heat recovery steam generator (HRSG) of the combined cycle power plant of FIG. 1, where the recuperator unit is integrated with the HRSG, according to aspects of the present specification; and

FIG. 3 is a schematic representation of one embodiment of a portion of the HRSG of FIG. 2, where the recuperator unit is integrated with a high pressure stage of the HRSG, according to aspects of the present specification.

### DETAILED DESCRIPTION

Embodiments of various systems and methods presented herein provide enhanced efficiency in combined cycle power plants. Use of these systems circumvents the need for expensive extra ducting and other structures in a heat recovery steam generator (HRSG) in the combined cycle power plants. Additionally, these systems and methods result in enhanced combined cycle efficiency of a recuperated gas turbine as hot exhaust gas is available for steam superheating, reheating, and recuperation.

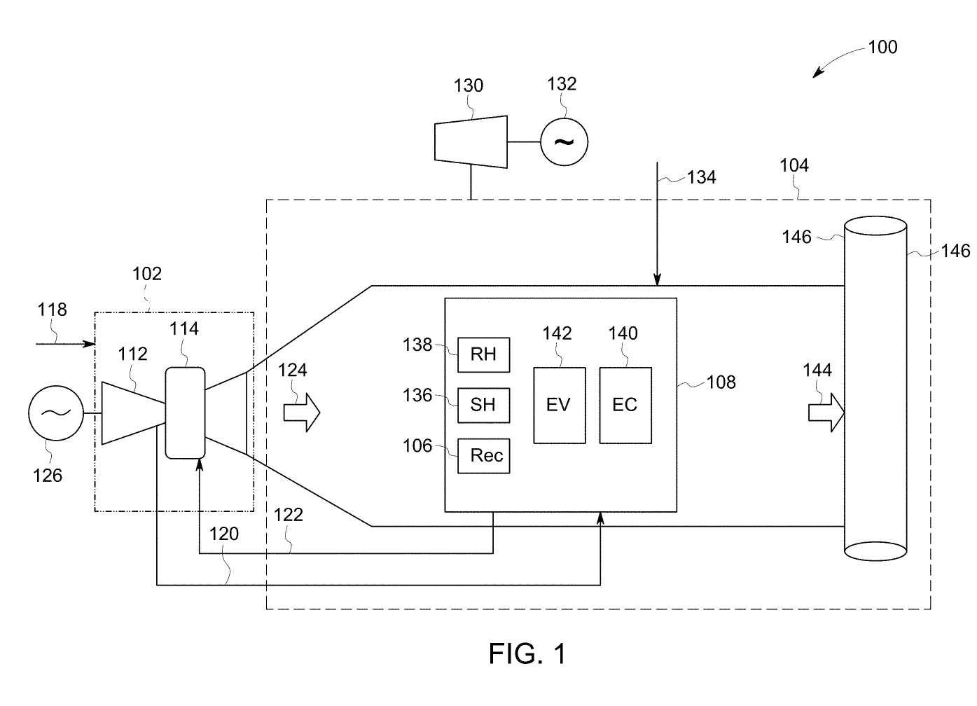

FIG. 1 is a block diagram representation of a combined cycle power plant 100, according to aspects of the present specification. The combined cycle power plant 100 includes a gas turbine 102 and a heat recovery steam generator (HRSG) 104 that is in fluid communication with the gas turbine 102.

The gas turbine 102 is used to generate electrical power using a gaseous or liquid fuel. In one embodiment, the gas turbine 102 includes at least a compressor 112, a combustor 114, and a diffuser 116. The compressor 112 is configured to receive air 118 from the atmosphere and compress the air to a determined pressure to generate compressed air 120. The compressor 112 is also configured to convey the compressed air 120 to a recuperator unit 106 of the HRSG 104.

Moreover, the HRSG 104 is configured to recover heat from a hot gas stream and use the recovered heat to produce steam. This steam may be used to drive a steam turbine 130 to generate additional electrical power. In one embodiment, the HRSG 104 includes a HRSG duct 108. In a presently contemplated configuration, the HRSG duct 108 is in fluid communication with the gas turbine 102. In one embodiment, the HRSG duct 108 may have a rectangular cross-section. Furthermore, the HRSG 104 further includes one or more steam heater units that may be located within the HRSG duct 108. For ease of illustration, a single stage HRSG 104 is depicted in FIG. 1. However, use of 2-stage, the common 3-stage, or multi-stage HRSGs is also envisioned.

A recuperator unit is employed to preheat the air supplied to the combustor using heat from hot gas turbine exhaust. In conventional combined cycle power plants that include a heat exchanging unit such as the recuperator unit, the heat exchanging unit is located external to and upstream of the HRSG. Such embodiments typically include bulky recuperators and have a drawback of reduced efficiency of the steam cycle due to the non-availability of high-temperature exhaust gas for superheating and reheating.

These shortcomings of conventional combined cycle power plants or previous concepts of recuperated gas turbines are circumvented via use of the combined cycle power plant 100 presented in FIG. 1. More particularly, in accordance with aspects of the present specification, the recuperator unit 106 is integrated with the HRSG 104, thereby enhancing the efficiency of the combined cycle power plant 100 and reducing the pressure losses in the flow of the exhaust gases.

In accordance with aspects of the present specification, the recuperator unit 106 is integrated with the HRSG 104. More particularly, in certain embodiments, the recuperator unit 106 is integrated with the HRSG duct 108 of the HRSG 104. In certain embodiments, the recuperator unit 106 is a gas-gas heat exchanger and is configured to preheat the compressed/compressor air 120 generated by the compressor 112 of the gas turbine 102 to generate preheated compressed air 122. In accordance with aspects of the present specification, the recuperator unit 106 is configured to use hot gas turbine exhaust 124 to preheat the compressed air 120 discharged from the compressor 112 of the gas turbine 102 to generate preheated compressor discharge air 122. In addition, the recuperator unit 106 is configured to convey the preheated compressor discharge air 122 to the combustor 114 in the gas turbine 102. In one embodiment, the recuperator unit 106 may include a plurality of recuperator tubes. Further, in certain embodiments, the plurality of recuperator tubes is disposed in a direction perpendicular to the direction of flow of the gas turbine exhaust 124 in the HRSG duct 108. It may be noted that the terms gas turbine exhaust, exhaust gas, and exhaust gas flow have been used interchangeably. Also, the terms compressor air, compressed air, and compressor discharge air may be used interchangeably. In a similar fashion, the terms preheated compressed air, preheated compressor air, and preheated compressor discharge air may be used interchangeably.

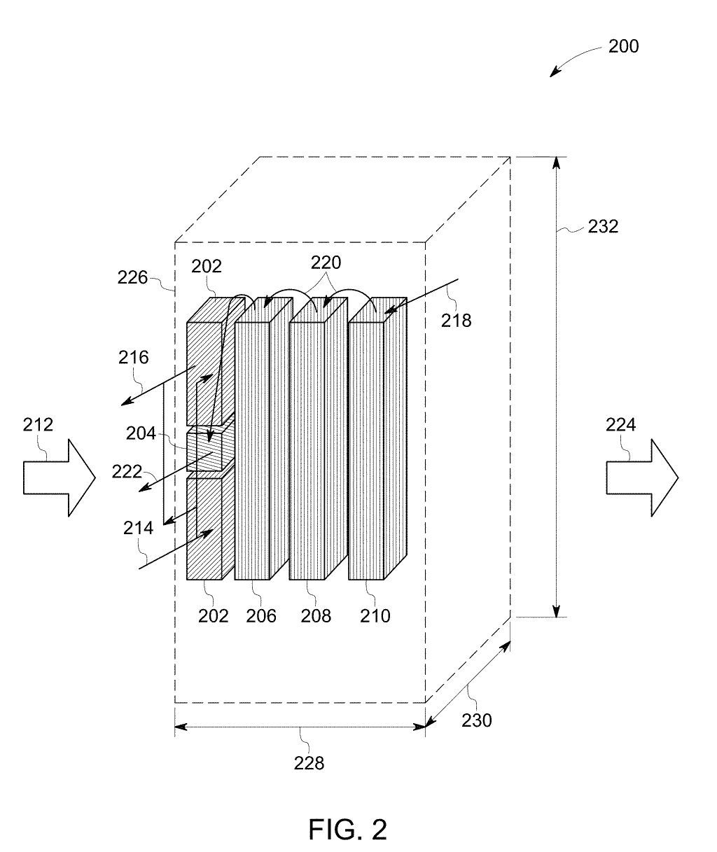

Preheating the compressor discharge air 120 generated by the compressor 112 and supplying that preheated compressor discharge air 122 to the combustor 114 aids in lowering the amount of fuel used for combustion in the combustor 114, thereby enhancing efficiency of the combined cycle power plant 100. The recuperator unit 106 will be described in greater detail with reference to FIG. 2.

Referring again to the gas turbine 102, the combustor 114 is used to combust a mixture of the fuel and the preheated compressor discharge air 122. To this end, the combustor 114 is supplied with a determined quantity of the fuel from a fuel reserve (not shown). In one embodiment, the fuel may include natural gas. Upon combustion of the mixture of the fuel and the preheated compressor discharge air 122, energy is extracted from the gas turbine 102 and may be used to generate electrical power using a power generator 126.

With returning reference to the HRSG 104, the HRSG 104 is used to generate steam using the heat of the gas turbine exhaust 124. The steam generated by the HRSG 104 is used to drive a steam turbine 130 for generating additional electrical power via a generator 132.

As previously noted, the HRSG 104 includes one or more steam heater/generator units. These steam heater units are configured to receive feed water 134 and convert the feed water 134 to steam via use of the heat recovered from the gas turbine exhaust 124. In certain embodiments, the HRSG 104 may include a steam super heater unit 136 and a steam reheater unit 138. In one embodiment, the steam super heater unit 136 and/or the steam reheater unit 138 may include a plurality of steam heater tubes. Also, in certain embodiments, the steam heater tubes in the steam super heater unit 136 and/or the steam reheater unit 138 may include finned tubes. Additionally, these steam heater tubes may be disposed in the HRSG duct 108 between the gas turbine 102 and an HRSG exhaust outlet stack 146. Also, the HRSG 104 may also include an economizer unit 140 and an evaporator unit 142 that are configured to aid in converting the feed water 134 into steam via use of the heat recovered from the gas turbine exhaust 124.

As previously noted, the recuperator unit 106 is configured to extract heat from the gas turbine exhaust 124 to preheat the compressor discharge air 120 prior to combustion by the combustor 114. In accordance with aspects of the present specification. A first subset of the one or more steam heater units in the HRSG 104 is disposed in parallel to the recuperator unit 106 and a second subset of the one or more steam heater units is disposed in series with the first subset of the one or more steam heater units and the recuperator unit 106 with respect to a direction of flow of the gas turbine exhaust 124 (see FIG. 2). In one example, the super heater unit 136 and the reheater unit 138 may be representative of the first subset of steam heater units, while the other steam heater units such as the economizer unit 140 and the evaporator unit 142 in the HRSG 104 may be representative of the other or second subset of steam heater units. This aspect will be described in greater detail with reference to FIG. 2.

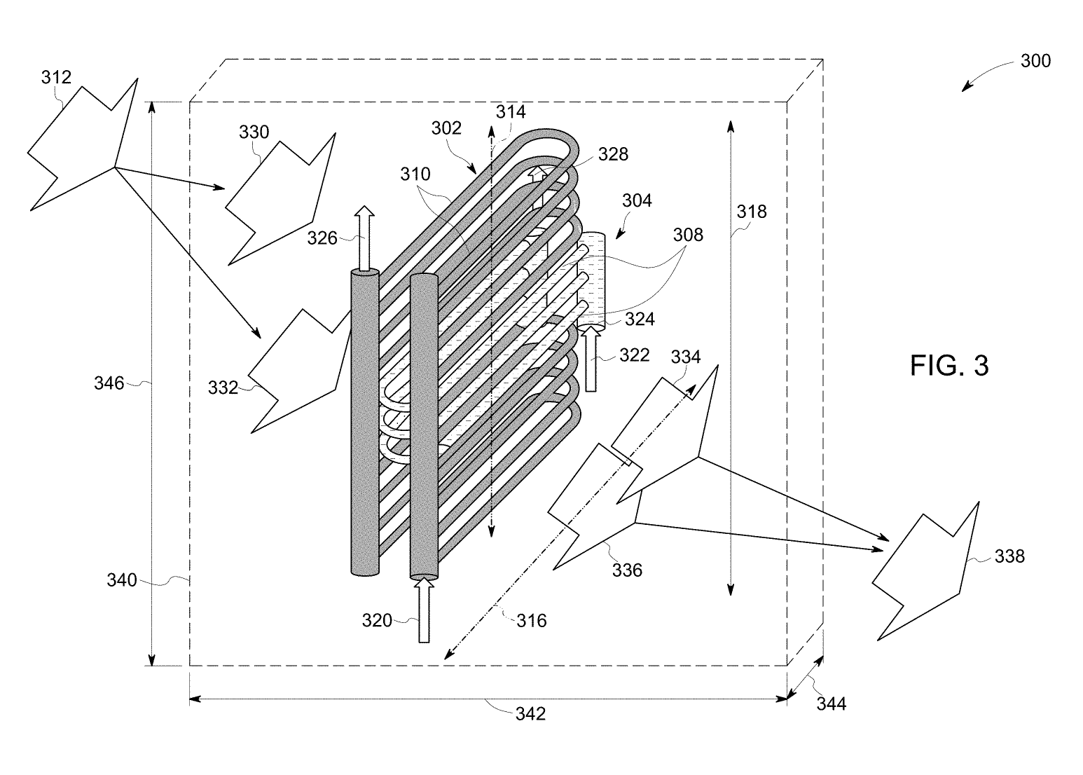

Moreover, in accordance with aspects of the present specification, the recuperator unit 106 may be integrated with one or more of the steam heater units of the HRSG 104. In a presently contemplated configuration, the recuperator unit 106 is integrated with the super heater unit 136 and/or the reheater unit 138 in a parallel configuration. More specifically, the recuperator unit 106 may be arranged such that the plurality of recuperator tubes is disposed in a parallel configuration with respect to the plurality of steam heater tubes in the super heater unit 136 and/or the steam reheater unit 138 (see FIG. 3). It may be noted that although for ease of illustration the recuperator unit 106 is shown as being integrated with the super heater unit 136 of the HRSG 104, the recuperator unit 106 may also be integrated with other steam heater units of the HRSG 104. Also, in accordance with further aspects of the present specification, the recuperator unit 106 is integrated with the one or more steam heater units in a configuration such that the gas turbine exhaust 124 flows in parallel across the recuperator unit 106 and the one or more steam heater units. Furthermore, the remaining or second subset of steam heater units in the HRSG 104 are arranged in series with the recuperator unit 106.

Additionally, the recuperator unit 106 and the super heater unit 136 may be arranged such that the corresponding tubes are oriented in parallel to a shorter side of the HRSG duct 108, such as the width of the HRSG duct 108. Moreover, the other steam heater units are positioned downstream of the recuperator unit 106 and the super heater unit 136 in the HRSG duct 108 such that corresponding tubes are oriented parallel to a longer side of the HRSG duct 108 and perpendicular to the tubes in the upstream units.

Consequent to the extraction of heat from the gas turbine exhaust 124 by the super heater unit 136 and the recuperator unit 106, cooled gas turbine exhaust 144 is generated. The cooled gas turbine exhaust 144 is conveyed over the tubes in the remaining steam heater units 138, 140, 142 situated downstream in the HRSG 104 towards the stack 146. Moreover, the cooled gas turbine exhaust 144 after passing through the HRSG 104 is channeled towards the stack 146, and the cooled gas turbine exhaust 144 is dispersed into the atmosphere via the stack 146.

Implementing the combined cycle power plant 100 where the integrated recuperator unit 106 is integrated with the HRSG 104 as described hereinabove facilitates enhanced efficiency of the combined cycle power plant 100 as the gas turbine exhaust 124 from the gas turbine 102 facilitates preheating of the compressor discharge air 120 prior to combustion in the gas turbine 102 in addition to generating steam using the HRSG 104. Use of the preheated compressor discharge air 122 reduces the quantity of fuel required for combustion, thereby further improving the efficiency of the combined cycle power plant 100.

Also, as previously noted, the tubes corresponding to the other steam heater units in the HRSG 104 are oriented parallel to the longer side of the HRSG duct 108 and perpendicular to the tubes in the upstream units. This arrangement allows a reduction in the number of tubes, thereby lowering associated costs of the HRSG 104, while promoting natural circulation in the evaporator unit in the HRSG 104. Furthermore, the presently contemplated configuration of FIG. 1 is immune to any difference in temperatures between independent gas turbine exhaust flow streams leaving the recuperator unit 106 and the super heater unit 136.

Moreover, in the embodiment of FIG. 1, the recuperator unit 106 is integrated with at least one of the steam heater units in a parallel configuration with respect to the direction of flow of the gas turbine exhaust 124. This arrangement of the recuperator unit 106 allows use of tubes that are substantially similar to the steam heater tubes as the recuperator tubes. Consequent to integrating the recuperator unit 106 with the HRSG 104 by disposing the recuperator unit 106 in the HRSG duct 108 and using recuperator tubes that are similar to the steam heater tubes aids in reducing the cost of the recuperator unit 106 and in turn that of the combined cycle power plant 100.

Additionally, in the example of FIG. 1, the steam heater units are configured to extract heat from a first portion of the gas turbine exhaust 124 for high-temperature steam generation, while the recuperator unit 106 is configured to extract heat from the remaining portion (second portion) of the gas turbine exhaust 124 during operation of the combined cycle power plant 100. In particular, the first portion of the exhaust gas 124 includes a smaller portion (for example, about 30%) of the hot gas turbine exhaust 124 that is employed for high-temperature steam superheating, while the remaining larger second portion (for example, about 70%) of the gas turbine exhaust 124 is channeled over the recuperator tubes, thereby decreasing gas turbine fuel input.

Furthermore, this exemplary configuration circumvents the need for extra ducting, flow split baffles and related structures to split and guide two separate exhaust gas streams for steam generation and recuperation that are typically used in the currently available combined cycle power plants with recuperators. Also, the arrangement of FIG. 1 aids in reducing the costs associated with the combined cycle power plants in comparison alternative concepts of combined cycle power plants that have a separate recuperator unit with extra ducting in addition to an HRS G. Hence, the presently contemplated configuration of the combined cycle power plant 100 of FIG. 1 aids in enhancing the overall efficiency of the combined cycle power plant 100.

As noted with reference to FIG. 1, in accordance with aspects of the present specification, the recuperator unit 106 may be integrated with one or more steam heater units of the HRSG 104. FIG. 2 is a schematic representation 200 of an embodiment of an HRSG having a recuperator unit 202 that is integrated with a super heater unit 204 of the HRSG such as the HRSG 104 of FIG. 1. FIG. 2 is described with reference to the components/elements of FIG. 1. More particularly, in the example of FIG. 2, the recuperator unit 202 is depicted as being integrated with a super heater unit 204 of the HRSG 200.

In the embodiment of FIG. 2, the recuperator unit 202 is disposed in a parallel configuration with respect to the super heater unit 204. In certain other embodiments, the recuperator unit 202 may also be disposed in a parallel configuration with respect to the super heater unit 204 and the reheater unit 206. As previously noted with respect to FIG. 1, the recuperator unit 202 typically includes a plurality of recuperator tubes, while each steam heater unit of the HRSG 200 includes a plurality of steam heater tubes (shown in FIG. 3). In a presently contemplated configuration, the recuperator tubes of the recuperator unit 202 are disposed in parallel with respect to the steam heater tubes of the super heater unit 204. Furthermore, the other steam heater units in the HRSG 200 are disposed in series with the super heater unit 204 and the recuperator unit 202 with respect to a direction of flow of gas turbine exhaust 212. In one example, reference numeral 206 is representative of a reheater unit, while an evaporator unit is represented by reference numeral 208. Also, reference numeral 210 is used to represent an economizer unit.

Thus, in the example embodiment of FIG. 2, the first subset of the steam heater units disposed in parallel to the recuperator unit includes the super heater unit 204, and the second subset of the steam heater units disposed in series with the first subset of the steam heater units and the recuperator unit includes the reheater unit 206, the evaporator unit 208, and the economizer unit 210. However, in other embodiments, the first subset of the steam heater units disposed in parallel to the recuperator unit may include the super heater unit 204 and the reheater unit 206, while the second subset of the steam heater units disposed in series with the first subset of the steam heater units and the recuperator unit includes the evaporator unit 208, and the economizer unit 210.

Moreover, in certain embodiments, all the steam heater units 204, 206, 208, 210 are made of finned tubes. Also, these steam heater units are housed in a large HRSG duct 226. Reference numeral 228 is representative of a length of the HRSG duct 226, while a width of the HRSG duct 226 is represented by reference numeral 230. Also, a height of the HRSG duct 226 is represented by reference numeral 232.

Furthermore, the recuperator unit 202 is configured to preheat compressor discharge air 214 (via use of hot gas turbine exhaust 212) prior to the compressor discharge air 214 being supplied to the combustor 114. Also, the steam heater units 204, 206, 208, 210 of the HRSG 200 use both the hot gas turbine exhaust 212 and exhaust gas that has been cooled after exchange of heat with the recuperator unit 202 (cooled gas turbine exhaust 224) to preheat, boil and superheat feed water 218 to generate steam.

As previously noted and shown in FIG. 3, the recuperator unit 202 of FIG. 2 includes the plurality of recuperator tubes. In accordance with aspects of the present specification, the recuperator tube bundles are oriented in parallel to a shorter side of the HRSG duct 226, such as the width 230 of the HRSG duct 226. Additionally, steam heater tubes corresponding to the hottest sections of the HRSG 200 are oriented in parallel to the shorter side 230 of the HRSG duct 226. As used herein, the term “the hottest sections of the HRSG” refers to the steam heater tube modules that are mounted in parallel to the recuperator tube modules of the recuperator unit 202. Further, steam heater tube modules corresponding to the remaining steam heater units 206, 208, 210 are oriented parallel to a longer side of the HRSG duct 226 such as the height 232 of the HRSG duct 226.

In the example of FIG. 2, the steam heater tube modules corresponding to the super heater unit 204 the HRSG 200 are disposed in parallel to the recuperator tube modules. More particularly, the steam heater tube modules corresponding to the super heater unit 204 and the recuperator tube modules are disposed such that the tube bundles share a common frontal area downstream of the diffuser 116 in a transition portion of the HRSG 108. In certain embodiments, the transition portion of the HRSG duct 108 may be representative of a portion of the HRSG duct 108 that is disposed proximate the gas turbine 10 and aids in coupling the HRSG duct 108 to the gas turbine 102. Implementing the HRSG 200 where the recuperator unit 202 is integrated with the HRSG duct 226 advantageously results in a reduction in the cost of the recuperator unit 202. Additionally, this arrangement also allows steam heater tubes corresponding to the hottest sections of the HRSG 200 to be used in the recuperator unit 202.

Accordingly, in certain embodiments, the recuperator tubes of the recuperator unit 202 and the steam heater tubes of the super heater unit 204 are substantially similar. By way of example, the tubes used in the recuperator unit 202 and the hottest section of the HRSG 200 such as the super heater unit 204 may have substantially similar dimensions, shapes, lengths, diameters, circumferences, sizes, or combinations thereof. In one embodiment, the dimensions, shapes, lengths, diameters, circumferences, sizes, or combinations thereof of the recuperator tubes may be identical or equal to the corresponding dimensions, shapes, lengths, diameters, circumferences, sizes, or combinations thereof of the steam heater tubes of the super heater unit 204. Moreover, in some embodiments, the outer dimensions of the recuperator tubes of the recuperator unit 202 and the steam heater tubes of the super heater unit 204 may be similar. Also, in this example, wall thickness of the recuperator tubes and the steam heater tubes may be similar. In alternative embodiments, the wall thickness of the recuperator tubes and the steam heater tubes may be different. In addition, in some embodiments, the tubes in the recuperator unit 202 and the super heater unit 204 may be formed using the same material. However, in some other embodiments, different materials may be used to form the recuperator tubes and the steam heater tubes.

Furthermore, the recuperator tube are installed in a counter-cross flow arrangement with the gas turbine exhaust 212. Additionally, in the embodiment of FIG. 2, the super heater unit 204 is configured to extract heat from a smaller first portion of the gas turbine exhaust 212 to generate high-temperature steam, while the recuperator unit 202 is configured to extract heat from a larger remaining portion of the gas turbine exhaust 212 during operation of the combined cycle power plant 100 to generate preheated compressor discharge air, thereby decreasing gas turbine fuel input.

Moreover, as depicted in FIG. 2, compressor discharge air 214 from the compressor 112 of the gas turbine 102 is supplied to the recuperator unit 202. The heat from the gas turbine exhaust 212 is used to heat the compressor discharge air 214. Consequent to this heat exchange, preheated compressor discharge air 216 is channeled out of the recuperator unit 202. It may be noted that since the recuperator tube modules are installed in a counter-cross flow arrangement with the gas turbine exhaust 212, the compressor discharge air 214 entering the recuperator unit 202 may be heated towards the temperature of the gas turbine exhaust 212 prior to exiting the recuperator unit 202. Accordingly, in certain examples, the preheated compressor discharge air 216 exiting the recuperator unit 202 may have a temperature that is substantially similar to the temperature of the gas turbine exhaust 212.

The preheated compressor discharge air 216 may then be conveyed to the combustor 114 of the gas turbine 102 (see FIG. 1). Use of the preheated compressor discharge air 216 aids in reducing the fuel consumption needed in the combustor 114. In addition, when the recuperator tube modules of the recuperator unit 202 are arranged in parallel to the shorter side 230 of the HRSG duct 226, shorter tubes may be used than in the remaining sections of the HRSG 200, which in turn reduces the pressure loss of the air inside the recuperator tube modules. Moreover, the exemplary arrangement depicted in FIG. 2 allows use of a smaller first portion of the hot gas turbine exhaust 212 for high-temperature steam superheating, while a remaining larger second portion of the hot gas turbine exhaust 212 is channeled over the recuperator tubes, thereby decreasing gas turbine fuel input.

Also, as previously noted, the recuperator unit 202 and the hottest sections 204 of the HRSG 200 such as the super heater unit 204 have tubes oriented in parallel to the shorter side 230 of the HRSG duct 226 and the remaining steam generator sections 206, 208, 210 have tubes oriented parallel to the longer side 232 of the HRSG duct 226. Further, consequent to the heat exchange in the super heater unit 204, the first portion of the hot gas turbine exhaust 212 is cooled as the gas turbine exhaust passes over the super heater 204. Similarly, the second portion of the hot gas turbine exhaust 212 is cooled consequent to the heat exchange in the recuperator unit 202.

The cooled first and second portions of the gas turbine exhaust are subsequently channeled over the steam heater tubes in the remaining sections of the HRSG 200 towards the stack 146. Reference numeral 224 is generally representative of gas turbine exhaust that has been channeled through the HRSG 200.

Further, the steam tube modules in the other sections of the HRSG 200 such as the units 206, 208, 210 have the tubes typically oriented parallel to the longer side 232 of the HRSG duct 226 and perpendicular to the tubes in the tube modules upstream. This arrangement of the tube modules promotes natural circulation in the evaporator unit 208. Additionally, the arrangement of the tube modules depicted in FIG. 2 also results in a reduction of the number of tubes and associated welding, thereby resulting in lowered cost of the HRSG 200.

Moreover, feed water 218 is provided to the HRSG 200. In the example depicted in FIG. 2, the feed water 218 is provided to the economizer unit 210. The economizer unit 210 is configured to warm/heat the feed water 218. The warmed/heated feed water 218 is converted to saturated steam via use of the evaporator unit 208. This saturated steam is channeled to the super heater unit 204, where the super heater unit 204 is configured to raise temperature of saturated steam to generate superheated steam 222. Reference numeral 220 is used to generally represent a flow of feed water 218/steam through the various units of the HRSG 200.

Furthermore, the steam or feed water 218 in most of the steam heater units of the HRSG 200 predominantly flows in a counter cross-flow direction to the gas turbine exhaust 212. Since the tubes in super heater unit 204 are perpendicular to the tubes in the remaining steam heater units downstream, any temperature difference in exhaust gas streams leaving the recuperator unit 202 and super heater unit 204, which result from a difference in the corresponding amounts of heat recovered from the gas turbine exhaust 212 will not cause differences in the duty of individual tubes of the downstream steam heater units.

The cooled gas turbine exhaust 224 flows over the tubes in the remaining steam heater units situated downstream in the HRSG 200. Subsequently, the cooled gas turbine exhaust 224 after passing through the HRSG 200 is channeled into the stack 146 and dispersed into the atmosphere via the stack 146.

Implementing the HRSG 200 having an integrated recuperator unit 202 as depicted in FIG. 2 allows a reduction in the cost of the recuperator unit 202 as the recuperator unit 202 is positioned in the HRSG duct 108. Additionally, the cost of the recuperator unit 202 is reduced as typical tubes used in hot HRSG sections may be used in the recuperator unit 202. Moreover, the arrangement of FIG. 2 aids in enhancing the combined cycle performance by using a small fraction of the hot gas turbine exhaust for high-temperature steam superheating, while the larger part of the gas turbine exhaust passes the recuperator tube modules for decreasing gas turbine fuel input.

As previously noted, in accordance with aspects of the present specification, the recuperator unit 106 is integrated with one or more steam heater units of the HRSG 104. FIG. 3 is a schematic representation 300 of one embodiment of a portion of the HRSG of FIG. 2, where a recuperator unit 302 is integrated with a super heater unit 304 of the HRSG 200. Moreover, in certain embodiments, the steam heater units such as the super heater unit 304 and the recuperator unit 302 are housed in a large HRSG duct 340. Reference numeral 342 is representative of a length of the HRSG duct 340, while a width of the HRSG duct 340 is represented by reference numeral 344. Also, a height of the HRSG duct 340 is represented by reference numeral 346. FIG. 3 is described with reference to the components/elements of FIGS. 1-2.

In the presently contemplated configuration of FIG. 3, the recuperator unit 302 is integrated with a super heater unit 306 of the HRSG 300. Also, the super heater unit 306 may be representative of the super heater unit 136 of FIG. 1. In addition, steam heater units such as the super heater unit 304 of the HRSG 300 includes a plurality of steam heater tubes 308. Two or more of these steam heater tubes 308 may be bundled to form one or more steam heater tube modules. Also, the steam heater tubes 308 may be arranged along one or more rows.

The recuperator unit 302 includes a plurality of recuperator tubes 310. Also, two or more recuperator tubes 310 of the plurality of tubes 310 may be bundled together to form one or more recuperator tube modules or bundles. In one example, the recuperator tubes 310 are coupled together to form a tubular recuperator unit 302. Moreover, the recuperator tubes 310 may be arranged along one or more rows. In certain embodiments, the recuperator tubes 310 may include external fins. Furthermore, these tube modules are installed in a counter-cross flow arrangement with respect to a flow of hot gas turbine exhaust 312 from a gas turbine such as the gas turbine 102.

Moreover, in accordance with aspects of the present specification, the recuperator unit 302 is integrated with the super heater unit 306 such that the recuperator unit 302 and the super heater unit 306 are in a parallel configuration with respect to each other and share a common cross-sectional axis 314. In one example, the steam heater tube modules of the super heater unit 304 and/or the reheater unit of the HRSG 300 are installed in parallel to the recuperator tube modules of the recuperator unit 302 and share a common frontal area after the diffuser 114 and the HRSG duct 340.

Additionally, in some embodiments, the recuperator unit 302 is integrated with the super heater unit 306 such that the recuperator unit 302 is disposed perpendicular to a direction of flow of the gas turbine exhaust 312 from the gas turbine 102. Consequently, the recuperator unit 302 is disposed such that the recuperator tubes 310 are arranged along an axis 316. This axis 316 is generally representative of a shorter side such as the width 344 of the HRSG duct 340. In particular, since the recuperator tubes 310 are arranged in parallel to the shorter side 344 of the HRSG duct 340, tubes of shorter length may be used in the recuperator unit 302 in comparison to the tubes in the other steam heater units of the HRSG 104. This arrangement aids in reducing pressure loss of the air inside the recuperator tubes 310.

In the embodiment where the recuperator unit 302 is integrated with the super heater unit 306, both the super heater unit 306 and the recuperator unit 302 are mounted such that the plurality of recuperator tubes 310 and the plurality of steam heater tubes 308 corresponding to super heater unit 306 are positioned horizontally along the axis 316. Additionally, in this example, other steam heater units of the HRSG may be positioned such that steam heater tubes corresponding to these other steam heater units are mounted vertically an axis 318. This axis 318 is generally representative of a longer side such as the height 346 of the HRSG duct 340. Furthermore, as the super heater unit 306 and the recuperator unit 302 share the common cross-sectional axis 314, the super heater unit 306 and the recuperator unit 302 are in the parallel configuration with respect to one another and the direction of flow of the gas turbine exhaust 312. This configuration of the recuperator unit 302 and the super heater unit 306 allows the gas turbine exhaust 312 to simultaneously pass through the recuperator unit 302 and the super heater unit 306 in a perpendicular direction to the tubes 308, 310.

Moreover, the gas turbine exhaust 312 that passes over the plurality of recuperator tubes 310 of the recuperator unit 302 allows exchange of heat between the gas turbine exhaust 312 and the compressed air 320 in the recuperator unit 302. This exchange of heat aids in heating the compressed air 320 in the recuperator unit 302 to generate preheated compressed air 326. In particular, the compressed air 320 is heated towards the temperature of the gas turbine exhaust 312 as the compressed air 320 is circulated through the recuperator tubes 308 to generate the heated compressed air 326. The heated compressed air 326 is channeled out of the recuperator unit 302 and conveyed to the combustor 112 of the gas turbine 102. It may be noted that in other examples, the location of supply of the compressed air 320 and the location of the egress of the heated compressed air 326 may be interchanged.

Furthermore, the gas turbine exhaust 312 that passes over the steam heater tubes 308 of the super heater unit 306 facilitates exchange of heat between the gas turbine exhaust 312 and the 322 to generate high temperature steam 328. This high temperature steam 328 may also be referred to as super-heated steam 328. Also, the super-heated steam 328 is conveyed out of the super heater unit 306 to the steam turbine 132 for generating additional electrical power.

As previously noted, a first, smaller portion 330 of the gas turbine exhaust 312 is channeled over the super heater unit 330 and other steam heater units, while a second, larger portion 332 of the gas turbine exhaust 312 is channeled over the recuperator unit 302. Consequent to the heat exchange between the first portion 320 of the hot gas turbine exhaust 312 and the steam 322 in the steam heater tubes 308, the temperature of the first portion 330 of the gas turbine exhaust 312 is reduced. Reference numeral 334 is generally representative of a cooled first portion of the gas turbine exhaust. Similarly, the temperature of the second portion 332 of the gas turbine exhaust 312 is reduced due to the heat exchange between the second portion 322 of the hot gas turbine exhaust 312 and the compressed air 320 in the recuperator tubes 310. Reference numeral 336 is generally representative of a cooled second portion of the gas turbine exhaust. Also, the first and second cooled portions 334, 336 of the gas turbine exhaust may be combined to form a cooled gas turbine exhaust 338.

The cooled gas turbine exhaust 338 flows over the tubes in the remaining steam heater units situated downstream in the HRSG 104 towards the stack 146. Moreover, the cooled gas turbine exhaust 338 after passing through the HRSG 104 is channeled into the stack 146 and dispersed into the atmosphere via the stack 146.

Moreover, as will be appreciated, it is desirable to maintain a desired flow ratio of the first, smaller portion 330 of the gas turbine exhaust 312 that passes over the steam heater tubes 308 in the super heater unit 306 and/or the reheater unit and the second, larger portion 332 of the gas turbine exhaust 312 that passes over the recuperator tubes 310 in the recuperator unit 306. In accordance with aspects of the present specification, the desired flow ratio may be maintained by varying/adjusting a plurality of HRSG parameters. More particularly, one or more of the plurality of HRSG parameters may be adjusted to maintain the desired flow ratio of the gas turbine exhaust 312 passing over the recuperator unit 302 and the super heater unit 306. Some examples of the HRSG parameters include, but are not limited to, number of rows of steam heater tubes in each stage of the HRSG 104, number of steam heater tubes per row in the HRSG 104, spacing between the steam heater tubes, and a number of external fins on each steam heater tube.

In one example, if the number of rows of steam heater tubes 308 and recuperator tubes 310 and the number of external fins on the steam heater tubes 308 and recuperator tubes 310 in the super heater unit 306 and the recuperator unit 302 are the same, the flow ratio of the gas turbine exhaust 312 in each of the super heater unit 306 and the recuperator unit 302 is dependent on a ratio of a number of tubes in each row of the super heater unit 306 and the recuperator unit 302. However, if the number of rows of tubes in each heat recovery stage, number of tubes in each row, and the number of external fins on each tube in the super heater unit 306 and the recuperator unit 302 are different, then the super heater unit 306 and the recuperator unit 302 are designed such that for a determined flow rate a gas turbine exhaust pressure loss in the super heater unit 306 and the recuperator unit 302 are the same.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this specification. It is, therefore, to be understood that the appended claims are intended to cover all such modifications and changes as fall within the true spirit of the invention.

Various embodiments of systems and methods described hereinabove present a combined cycle power plant with enhanced efficiency. The combined cycle power plant includes a recuperator unit that is integrated with an HRS G. The exemplary configuration increases the efficiency of the combined cycle power plant as a gas turbine exhaust from a gas turbine in the combined cycle power plant is available for steam generation using the HRSG and also for recuperation using the recuperator unit. Furthermore, the recuperator unit that is integrated with at least one of the heat recovery stages of the HRSG facilitates preheating of compressed air prior to combustion in the gas turbine. Use of the preheated compressed air reduces the quantity of fuel required for combustion of the preheated compressed air, thereby improving the efficiency of the combined cycle power plant.

Moreover, the recuperator unit is integrated with at least one of the heat recovery stages and in a parallel configuration with respect to a super heater unit of at least one heat recovery stage. This configuration of the recuperator unit reduces pressure losses of the gas turbine exhaust during operation of the combined cycle power plant as only a single gas turbine exhaust used for both steam generation and recuperation. The exemplary configuration of the combined cycle power plant 100 also obviates the need for extra ducting, flow split baffles, and/or other related structures to split and guide two separate exhaust gas streams for steam generation and recuperation that are typically required in alternative concepts of the combined cycle power plants with recuperators. Also, embodiments of the combined cycle power plant presented herein result in reduced cost of the HRSG that includes the recuperator unit as the recuperator unit is formed using tubes that are typically used in the HRSG. Moreover, the exemplary recuperator unit may be retrofit to existing HRSGs for improving the efficiency of existing combined cycle power plants.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A combined cycle power plant, comprising:
a gas turbine comprising at least a compressor and a combustor;
a heat recovery steam generator disposed in fluid communication with the gas turbine, wherein the heat recovery steam generator comprises steam heater units;
a recuperator unit, wherein the recuperator unit is integrated with the heat recovery steam generator, and wherein the recuperator unit is configured to:
use gas turbine exhaust from the gas turbine to preheat compressor discharge air from the compressor; and
supply the preheated compressor discharge air to the combustor,
wherein a first subset of the steam heater units is disposed in parallel to the recuperator unit, and wherein a second subset of the steam heater units is disposed in series with the first subset of the steam heater units and the recuperator unit with respect to a direction of flow of the gas turbine exhaust.

2. The combined cycle power plant of claim 1, wherein the heat recovery steam generator further comprises a heat recovery steam generator duct disposed in fluid communication with the gas turbine, and wherein the heat recovery steam generator duct has a rectangular cross-section.

3. The combined cycle power plant of claim 1, wherein the recuperator unit comprises a plurality of recuperator tubes.

4. The combined cycle power plant of claim 3, wherein the steam heater units comprise a steam super heater unit, a steam reheater unit, an evaporator unit, and an economizer unit, and wherein one or more of the steam super heater unit, the steam reheater unit, and the evaporator unit comprise a plurality of steam heater tubes.

5. The combined cycle power plant of claim 4, wherein the plurality of steam heater tubes corresponding to the steam heater units and the plurality of recuperator tubes corresponding to the recuperator unit have similar dimensions, shapes, lengths, diameters, circumferences, sizes, or combinations thereof.

6. The combined cycle power plant of claim 4, wherein the first subset of steam heater units comprises one or more of the steam super heater unit and the steam reheater unit, and wherein the second subset of steam heater units comprises at least the evaporator unit and the economizer unit.

7. The combined cycle power plant of claim 6, wherein the plurality of steam heater tubes corresponding to one or more of the steam super heater unit and the steam reheater unit of the first subset of steam heater units is disposed parallel to the plurality of recuperator tubes.

8. The combined cycle power plant of claim 6, wherein the plurality of recuperator tubes and the plurality of steam heater tubes corresponding to one or more of the steam super heater unit and the steam reheater unit of the first subset of steam heater units are disposed parallel to a shorter side of the heat recovery steam generator duct.

9. The combined cycle power plant of claim 6, wherein the plurality of steam heater tubes corresponding to steam heater units of the second subset of steam heater units positioned downstream of the recuperator unit and the first subset of steam heater units in the heat recovery steam generator duct are disposed parallel to a longer side of the heat recovery steam generator duct.

10. The combined cycle power plant of claim 1, wherein the recuperator unit is integrated with the one or more steam heater units in a configuration such that the gas turbine exhaust flows in parallel across the recuperator unit and the first subset of steam heater units, and wherein the second subset of steam heater units are arranged in series with respect to the direction of flow of the gas turbine exhaust.

11. The combined cycle power plant of claim 10, wherein the recuperator unit and the at least one of the one or more steam heater units of the first subset of steam heater units are mounted along a common cross-section of a heat recovery steam generator duct.

12. The combined cycle power plant of claim 11, wherein the recuperator unit is integrated with the one or more steam heater units such that the recuperator unit is configured to receive one portion of the gas turbine exhaust and the one or more steam heater units are configured to receive a remaining portion of the gas turbine exhaust.

13. The combined cycle power plant of claim 12, wherein the at least one of the one or more steam heater units is configured to receive a first smaller portion of the gas turbine exhaust, and wherein the recuperator unit is configured to receive a second larger portion of the gas turbine exhaust.

14. The combined cycle power plant of claim 13, wherein the at least one of the one or more steam heater units is configured to use the first smaller portion of the gas turbine exhaust to super heat steam, and wherein the recuperator unit is configured to use the second larger portion of the gas turbine exhaust to preheat the compressor discharge air from the compressor.

15. A heat recovery steam generator, comprising:
one or more steam heater units;
a heat recovery steam generator duct;
a recuperator unit, wherein the recuperator unit is integrated with at least one of the one or more steam heater units, and wherein the recuperator unit is configured to:
use gas turbine exhaust from the gas turbine to preheat compressor discharge air from the compressor; and
supply the preheated compressor discharge air to the combustor,
wherein a first subset of the one or more steam heater units is disposed in parallel to the recuperator unit, and wherein a second subset of the one or more steam heater units is disposed in series with the first subset of the one or more steam heater units and the recuperator unit with respect to a direction of flow of the gas turbine exhaust.

16. The heat recovery steam generator of claim 15, wherein the recuperator unit is disposed in the heat recovery steam generator duct in a parallel configuration with respect to at least one of the one or more steam heater units and the direction of flow of the gas turbine exhaust.

17. The heat recovery steam generator of claim 15, wherein the recuperator unit and the at least one of the one or more steam heater units are mounted along a common cross-section of the heat recovery steam generator duct.

18. The heat recovery steam generator of claim 15, wherein a plurality of recuperator tubes in the recuperator unit and a plurality of steam heater tubes corresponding to one or more of the steam super heater unit and the steam reheater unit of the first subset of steam heater units are disposed parallel to a shorter side of the heat recovery steam generator duct.

19. The combined cycle power plant of claim 15, wherein a plurality of steam heater tubes corresponding to steam heater units of the second subset of steam heater units positioned downstream of the recuperator unit and the first subset of steam heater units in the heat recovery steam generator duct are disposed parallel to a longer side of the heat recovery steam generator duct.

20. A combined cycle power plant, comprising:
a gas turbine comprising at least a compressor and a combustor;
a heat recovery steam generator disposed in fluid communication with the gas turbine, wherein the heat recovery steam generator comprises:
steam heater units;
a heat recovery steam generator duct disposed in fluid communication with the gas turbine;
a recuperator unit configured to use gas turbine exhaust from the gas turbine to preheat compressor discharge air from the compressor and supply the preheated compressor discharge air to the combustor, wherein the recuperator unit is integrated with at least one of the steam heater units of the heat recovery steam generator such that a plurality of recuperator tubes in the recuperator unit is disposed perpendicular to a direction of flow of the gas turbine exhaust in the heat recovery steam generator duct, and wherein the plurality of recuperator tubes is arranged in a parallel configuration with the at least one of the steam heater units such that a first smaller portion of the gas turbine exhaust discharged by the gas turbine is channeled over the the at least one steam heater unit and a second larger portion of the gas turbine exhaust is channeled over recuperator unit; and
a steam turbine operatively coupled to the heat recovery steam generator and configured to generate additional electrical power,
wherein a first subset of the steam heater units is disposed in parallel to the recuperator unit, and wherein a second subset of the steam heater units is disposed in series with the first subset of the one or more steam heater units and the recuperator unit with respect to a direction of flow of the gas turbine exhaust.
